(19) United States
(12) Patent Application Publication
(10) Pub. No.: US 2025/0361721 A1
(43) Pub. Date: Nov. 27, 2025

(54) Gypsum Panel Containing a Maleic Anhydride Polymer

(71) Applicant: Gold Bond Building Products, LLC, Charlotte, NC (US)

(72) Inventors: Ratnasabapathy Gurunathan Iyer, Fort Mill, SC (US); Jillian Cirignano, Waxhaw, NC (US); Xing Yang, Charlotte, NC (US); Ju Dong, Charlotte, NC (US); Christopher R. Fenoli, Charlotte, NC (US)

(21) Appl. No.: 19/209,871

(22) Filed: May 16, 2025

Related U.S. Application Data
(60) Provisional application No. 63/651,457, filed on May 24, 2024.

(51) Int. Cl. E04B 2/72; B32B 13/08; C04B 24/26; C04B 28/14; C04B 103/00; C04B 103/40; C04B 111/00

(52) U.S. Cl. CPC E04B 2/723; C04B 24/2664; C04B 28/14; B32B 13/08; B32B 2250/03; B32B 2250/40; B32B 2607/00; C04B 2103/0039; C04B 2103/408; C04B 2111/0062

(57) ABSTRACT

The present disclosure is directed to a gypsum panel and a method of making such gypsum panel. For instance, the gypsum panel comprises a gypsum core and a first facing material and a second facing material sandwiching the gypsum core. The gypsum core includes gypsum and a maleic anhydride polymer comprising maleic anhydride repeating units present in an amount of more than 10 wt. % based on the weight of the maleic anhydride polymer. The method of the present disclosure is directed to making the aforementioned gypsum panel by providing the first facing material, providing a gypsum slurry comprising gypsum, water, and a maleic anhydride polymer onto the first facing material and providing a second facing material on the gypsum slurry.

### CROSS-REFERENCE TO RELATED APPLICATION

The present application claims filing benefit of U.S. Provisional Patent Application No. 63/651,457 having a filing date of May 24, 2024, which is hereby incorporated by reference in its entirety.

### BACKGROUND OF THE DISCLOSURE

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. These conventional additives may be utilized to improve certain attributes and properties of the gypsum panel. For instance, certain additives may be utilized to improve the fluidity of the gypsum slurry and/or reduce the amount of water required in forming the gypsum slurry and the resulting gypsum panel. However, while certain additives may exist that provide some benefits to the gypsum panel manufacturing process, it is still desired to find other alternatives.

In this regard, there is a need to provide an improved gypsum panel, particularly one allowing for improved fluidity of a gypsum slurry and/or reduction in water usage.

### SUMMARY OF THE DISCLOSURE

In accordance with one embodiment of the present disclosure, a gypsum panel is disclosed. The gypsum panel comprises a gypsum core comprising gypsum and a maleic anhydride polymer comprising maleic anhydride repeating units in an amount of more than 10 wt. % based on the weight of the maleic anhydride polymer. The gypsum panel further comprises a first facing material and a second facing material sandwiching the gypsum core.

In accordance with another embodiment of the present disclosure, a method of making a gypsum panel is disclosed. The method comprises: providing a first facing material; depositing a gypsum slurry comprising stucco, water, and a maleic anhydride polymer comprising maleic anhydride repeating units in an amount of more than 10 wt. % based on the weight of the maleic anhydride polymer onto the first facing material; providing a second facing material on the gypsum slurry; and allowing the stucco to convert to calcium sulfate dihydrate.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a gypsum panel and a method of making such gypsum panel. In particular, the gypsum panel can include a gypsum core including a maleic anhydride polymer as defined herein. In this regard, the gypsum core may include gypsum (i.e., calcium sulfate dihydrate), a maleic anhydride polymer, and other optional additives.

The present inventors have discovered that the gypsum panel manufacturing process disclosed herein can have various benefits due to the use of a maleic anhydride polymer. For instance, without intending to be limited, the present inventors have discovered that the use of such a polymer can allow for a process with a desired gypsum slurry fluidity in making the gypsum panel. In certain embodiments, the use of such a maleic anhydride polymer may also allow for an overall reduction in water usage compared to a process that utilizes conventional dispersants in the gypsum slurry and gypsum panel manufacturing process. In turn, such reduction in water may also result in a reduction in the amount of heat and/or drying time required during the drying process of the gypsum panel. As a result, such benefits may also allow for an increased manufacturing line speed thereby allowing for an increase in output of gypsum panel production. Furthermore, use of the maleic anhydride polymer as disclosed herein may still allow for producing a gypsum panel without sacrificing desired panel properties.

As indicated herein, a gypsum panel is disclosed. The gypsum panel comprises a gypsum core and a first facing material and a second facing material sandwiching the gypsum core. Furthermore, the gypsum core comprises gypsum and a maleic anhydride polymer.

In general, the gypsum core may comprise calcium sulfate dihydrate. The gypsum utilized in forming the gypsum slurry and resulting core may be from a natural source or a synthetic source and is thus not necessarily limited by the present disclosure. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less. In one embodiment, the aforementioned weight percentages are based on the weight of the gypsum core. In another embodiment, the aforementioned weight percentages are based on the weight of the gypsum panel. In a further embodiment, the aforementioned weight percentages are based on the weight of the solids in the gypsum slurry. The calcium sulfate dihydrate content of a gypsum panel may be determined by X-ray diffraction (XRD) analysis.

In some aspects, a gypsum panel formed in accordance with the present disclosure may have a calcium sulfate hemihydrate content of about 0.01 wt. % to about 10 wt. %, such as about 0.01 wt. % or more, such as about 0.05 wt. % or more, such as about 0.1 wt. % or more, such as about 0.2 wt. % or more, such as about 0.5 wt. % or more, such as about 0.8 wt. % or more, such as about 0.9 wt. % or more, such as about 1 wt. % or more, such as about 1.2 wt. % or more, such as about 1.5 wt. % or more, such as about 2 wt. % or more, such as about 3 wt. % or more, such as about 4 wt. % or more, such as about 5 wt. % or more. Generally, the calcium sulfate hemihydrate content of the gypsum panel is less than about 10 wt. %, such as about 8 wt. % or less, such as about 5 wt. % or less, such as about 4 wt. % or less, such as about 3 wt. % or less, such as about 2 wt. % or less, such as about 1.5 wt. % or less, such as about 1 wt. % or less, such as about 0.9 wt. % or less, such as about 0.8 wt. % or less, such as about 0.5 wt. % or less, such as about 0.2 wt. % or less, such as about 0.1 wt. % or less. In one embodiment, the aforementioned weight percentages are based on the weight of the gypsum core. In another embodiment, the aforementioned weight percentages are based on the weight of the gypsum panel. The calcium sulfate hemihydrate content of a gypsum panel may be determined by X-ray diffraction (XRD) analysis.

In addition, the gypsum core comprises a maleic anhydride polymer. It should be understood that the gypsum core disclosed herein may comprise more than one maleic anhydride polymer. For instance, the gypsum core disclosed herein may comprise two maleic anhydride polymers or three maleic anhydride polymers.

The maleic anhydride polymer may be a homopolymer, a copolymer, or a mixture thereof. In one embodiment, the maleic anhydride polymer may be a homopolymer. In this regard, in one embodiment, the maleic anhydride polymer may be a maleic anhydride homopolymer. For instance, the polymer may simply be made from maleic anhydride thereby including maleic anhydride repeating units. In another embodiment, the maleic anhydride polymer may be a copolymer.

As indicated herein, the maleic anhydride polymer includes repeating units of maleic anhydride. In this regard, the maleic anhydride may be substituted or unsubstituted. In one embodiment, the maleic anhydride may be unsubstituted. In another embodiment, the maleic anhydride may be substituted. For instance, it may be substituted with one or more substituent groups, such as two substituent groups. In one embodiment, such substituent groups may be an alkyl group, a carboxyl group, or a combination thereof. For instance, the alkyl group may be a C₁₋₁₀ alkyl group, such as a C₁₋₈ alkyl group, such as a C₁₋₆ alkyl group, such as a C₁₋₄ alkyl group, such as a C₁₋₃ alkyl group, such as a C₁₋₂ alkyl group, such as a C₁ alkyl group. In one embodiment, at least one substitution may be a methyl group. The carboxyl group may be a C₁ carboxyl group, a C₂ carboxyl group (e.g., acetic acid based), a C₃ carboxyl group (e.g., propionic acid based), etc. In one embodiment, one substitution may be an alkyl group while another substitution may be a carboxyl group. In a further embodiment, both substitutions may be alkyl groups.

Accordingly, the maleic anhydride repeating units may be formed from maleic anhydride, 2,3-dimethylmaleic anhydride (citraconic anhydride), 2-methylmaleic anhydride, aconitic anhydride, carboxydimethyl maleic anhydride, or a combination thereof. In one embodiment, the maleic anhydride repeating units may be formed from maleic anhydride.

As indicated above, the maleic anhydride polymer may be a maleic anhydride copolymer. For instance, the maleic anhydride polymer may be made from maleic anhydride and one or more ethylenically unsaturated monomers. Accordingly, such copolymer may include maleic anhydride repeating units and repeating units of the one or more ethylenically unsaturated monomers.

The one or more ethylenically unsaturated monomers may be any as generally known in the art. For instance, the ethylenically unsaturated monomer may be an olefin, an acrylic acid or an ester thereof, a vinyl ether, a vinyl ester, a vinyl halide, a vinyl aromatic, or a mixture thereof.

In one embodiment, the ethylenically unsaturated monomer may be an olefin. In this regard, the maleic anhydride polymer may be a maleic anhydride-olefin copolymer.

The olefin may be one as generally known in the art. In one embodiment, the olefin may be an α-olefin. The olefin may be a C₂-C₂₀ olefin, such as a C₂-C₂₀ α-olefin. For instance, the olefin may be a C₂-C₁₀ olefin, such as a C₂-C₁₀ α-olefin. Further, the olefin may be a C₂-C₈ olefin, such as a C₂-C₈ α-olefin. Even further, the olefin may be a C₆-C₈ olefin, such as a C₆-C₈ α-olefin. The olefin may have 2 or more, such as 3 or more, such as 4 or more, such as 5 or more, such as 6 or more, such as 7 or more, such as 8 or more, such as 9 or more, such as 10 or more carbon atoms. The olefin may have 20 or less, such as 18 or less, such as 16 or less, such as 14 or less, such as 12 or less, such as 10 or less, such as 9 or less, such as 8 or less, such as 7 or less, such as 6 or less, such as 5 or less, such as 4 or less, such as 3 or less carbon atoms.

The olefin may include, but is not limited to, ethylene, propylene, a butene (e.g., 1-butene, 3-methyl-1-butene, 3,3-dimethyl-1-butene, etc.), a pentene (e.g., 1-pentene, 2-methyl-1-propene, 3-methyl-1-pentene, 4-methyl-1-pentene, 2,4,4-trimethyl-1-pentene), a hexene (e.g., 1-hexene), a heptane (e.g., 1-heptene), an octene (e.g., 1-octene), a nonene (e.g., 1-nonene), a decene (e.g., 1-decene), a dodecene (e.g., 1-dodecene), etc. or a combination thereof.

In one embodiment, the olefin may be ethylene, propylene, butene, pentene, or a mixture thereof. In one embodiment, the olefin may be ethylene. In another embodiment, the olefin may be a butene. In a further embodiment, the olefin may be a pentene. In an even further embodiment, the olefin may be 2,4,4-trimethyl-1-pentene.

In one embodiment, the ethylenically unsaturated monomer may be a (meth)acrylic acid or an ester thereof. In this regard, the maleic anhydride polymer may be a copolymer of maleic anhydride and a (meth)acrylic acid or an ester thereof. In one embodiment, the maleic anhydride polymer may be a copolymer of maleic anhydride and a (meth)acrylic acid. In another embodiment, the maleic anhydride polymer may be a copolymer of maleic anhydride and an ester of (meth)acrylic acid.

In general, the (meth)acrylic acid or an ester thereof includes an acrylic acid, a methacrylic acid, and esters thereof. Similarly, a (meth)acrylate includes an acrylate as well as a methacrylate. In addition, the (meth)acrylate may be an alkyl ester of an acrylic acid and/or methacrylic acid. For instance, the alkyl ester may be a C₁-C₃₀ alkyl ester, such as a C₁-C₂₄ alkyl ester, such as a C₁-C₁₆ alkyl ester, such as a C₁-C₁₀ alkyl ester, such as a C₁-C₈ alkyl ester, such as a C₁-C₄ alkyl ester. The alkyl of the alkyl ester may have 2 or more, such as 3 or more, such as 4 or more, such as 5 or more, such as 6 or more, such as 7 or more, such as 8 or more, such as 9 or more, such as 10 or more, such as 12 or more, such as 14 or more, such as 16 or more, such as 18 or more carbon atoms. The alkyl of the alkyl ester may have 30 or less, such as 26 or less, such as 24 or less, such as 20 or less, such as 18 or less, such as 16 or less, such as 14 or less, such as 12 or less, such as 10 or less, such as 9 or less, such as 8 or less, such as 7 or less, such as 6 or less, such as 5 or less, such as 4 or less, such as 3 or less carbon atoms.

The acrylate may include, but is not limited to, methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof.

In one embodiment, the ethylenically unsaturated monomer may be a vinyl ether. In this regard, the maleic anhydride polymer may be a maleic anhydride-vinyl ether copolymer.

The vinyl ether may include, but is not limited to, divinyl ether, n-propyl vinyl ether, isopropyl vinyl ether, n-butyl vinyl ether, 2-hydroxyethyl vinyl ether, cyclohexanedimethanol monovinyl ether, diethylene glycol monovinyl ether, 4-hydroxybutyl vinyl ether, cyclohexyl vinyl ether, dodecyl vinyl ether, octadecyl vinyl ether, lauryl vinyl ether, cetyl vinyl ether, 2-ethylhexyl vinyl ether, etc. as well as mixtures thereof.

In one embodiment, the ethylenically unsaturated monomer may be a vinyl ester. In this regard, the maleic anhydride polymer may be a maleic anhydride-vinyl ester copolymer.

The vinyl ester may include, but is not limited to, those of carboxylic acids having 1 to 15 carbon atoms. For instance, it may have 1 or more, such as 2 or more, such as 3 or more, such as 5 or more, such as 8 or more, such as 10 or more carbon atoms. It may have 15 or less, such as 13 or less, such as 10 or less, such as 8 or less, such as 6 or less, such as 4 or less carbon atoms. These may include, but are not limited to, vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 carbon atoms, as well as mixtures thereof.

In one embodiment, the ethylenically unsaturated monomer may be a vinyl halide. In this regard, the maleic anhydride polymer may be a maleic anhydride-vinyl halide copolymer. The vinyl halide may include, but is not limited to, vinyl chloride.

In one embodiment, the ethylenically unsaturated monomer may be a vinyl aromatic. In this regard, the maleic anhydride polymer may be a maleic anhydride-vinyl aromatic copolymer.

The vinyl aromatic may include styrene, an alkyl styrene, an alkoxy styrene, or a mixture thereof. In one embodiment, the vinyl aromatic may be styrene. In another embodiment, the vinyl aromatic may be an alkyl styrene. In a further embodiment, the vinyl aromatic may be an alkoxy styrene.

The alkyl of the alkyl styrene may have 1 or more, such as 2 or more, such as 3 or more, such as 4 or more, such as 5 or more carbon atoms. The alkyl of the alkyl styrene may have 10 or less, such as 8 or less, such as 6 or less, such as 4 or less, such as 3 or less, such as 2 or less carbon atoms. The alkyl of the alkyl styrene may be methyl, ethyl, propyl (e.g., n-propyl, isopropyl), or butyl (e.g., n-butyl, t-butyl).

The alkoxy of the alkoxy styrene may have 1 or more, such as 2 or more, such as 3 or more, such as 4 or more, such as 5 or more carbon atoms. The alkoxy of the alkoxy styrene may have 10 or less, such as 8 or less, such as 6 or less, such as 4 or less, such as 3 or less, such as 2 or less carbon atoms. The alkoxy of the alkoxy styrene may be methoxy, ethoxy, propoxy (e.g., n-propoxy, isopropoxy), or butoxy (e.g., n-butoxy, t-butoxy).

As indicated, the styrene may be an alkyl styrene or an alkoxy styrene. In this regard, the styrene may have at least one substitution. The substitution may be at the ortho position, meta position, or para position. In one embodiment, the substitution may be at the para position. If multiple substitutions are present, they may be at two or more of the ortho position, meta position, or para position. For instance, in one embodiment, the substitutions may be at the para position and at least one of the ortho and meta positions, particular the ortho position (e.g., 2,4,6-trimethylstyrene). Furthermore, in one embodiment, the substitution may be at the alpha carbon (e.g., alpha-methyl styrene).

The maleic anhydride polymer may also include other auxiliary monomers. For instance, these may include, but are not limited to, other ethylenically unsaturated monocarboxylic and dicarboxylic acids (e.g., fumaric acid, maleic acid, crotonic acid, itaconic acid, etc.) (e.g., other than (meth) acrylic acid); monoesters and diesters of other ethylenically unsaturated monocarboxylic and dicarboxylic acids (e.g., of fumaric acid, maleic acid, such as diethyl or diisopropyl esters); ethylenically unsaturated carboxamides (e.g., acrylamide); ethylenically unsaturated carbonitriles (e.g., acrylonitrile); ethylenically unsaturated sulfonic acids and their salts (e.g., vinylsulfonic acid, 2-acrylamido-2-methylpropanesulfonic acid); etc. as well as mixtures thereof.

The maleic anhydride polymer may include partially or wholly hydrolyzed analogues and/or salts thereof. For instance, it may include a salt in one embodiment. The salt may be a metal salt, such as an alkali metal salt. For instance, the alkali metal may be lithium, sodium, potassium, etc. In one embodiment, the salt may be a sodium salt.

Such maleic anhydride polymer may be formed using standard polymerization techniques as generally known in the art. For instance, the polymer may be prepared via standard step-growth or chain-growth mechanisms. In addition, the polymer may be prepared using emulsion or suspension polymerization. In this regard, the polymer may be prepared in an aqueous medium. While not limited, one such method of polymerization may be as disclosed in U.S. Pat. No. 2,378,629, which is incorporated herein by reference in its entirety.

In addition, when such maleic anhydride polymer is a copolymer, it may be a random copolymer, an alternating copolymer, or a block copolymer. In one embodiment, such copolymer may be a random copolymer. In another embodiment, such copolymer may be an alternating copolymer. In a further embodiment, such copolymer may be a random copolymer.

When forming a maleic anhydride copolymer, different copolymers may be made with the same repeating units at different distributions. Regardless, the maleic anhydride (or maleic anhydride repeating units) may constitute 10 mol. % or more, such as 15 mol. % or more, such as 20 mol. % or more, such as 25 mol. % or more, such as 30 mol. % or more, such as 40 mol. % or more, such as 50 mol. % or more, such as 60 mol. % or more, such as 70 mol. % or more, such as 80 mol. % or more, such as 90 mol. % or more, such as 95 mol. % or more, such as 98 mol. % or more, such as 99 mol. % or more, such as 100 mol. % of the maleic anhydride polymer based on the total moles of monomers utilized in making the maleic anhydride polymer. The maleic anhydride (or maleic anhydride repeating units) may constitute 100 mol. % or less, such as 99 mol. % or less, such as 98 mol. % or less, such as 97 mol. % or less, such as 95 mol. % or less, such as 90 mol. % or less, such as 85 mol. % or less, such as 80 mol. % or less, such as 75 mol. % or less, such as 70 mol. % or less, such as 65 mol. % or less, such as 60 mol. % or less, such as 55 mol. % or less, such as 50 mol. % or less of the maleic anhydride polymer based on the total moles of monomers utilized in making the maleic anhydride polymer.

Related, the maleic anhydride (or maleic anhydride repeating units) may constitute more than 10 wt. %, such as 15 wt. % or more, such as 20 wt. % or more, such as 25 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more, such as 95 wt. % or more, such as 98 wt. % or more, such as 99 wt. % or more, such as 100 wt. % of the maleic anhydride polymer based on the weight of the maleic anhydride polymer. The maleic anhydride (or maleic anhydride repeating units) may constitute 100 wt. % or less, such as 99 wt. % or less, such as 98 wt. % or less, such as 97 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less of the maleic anhydride polymer based on the weight of the maleic anhydride polymer.

As indicated herein, the maleic anhydride polymer may be a copolymer made from maleic anhydride repeating units and repeating units derived from one or more ethylenically unsaturated monomers. The one or more ethylenically unsaturated monomers (or one or more ethylenically unsaturated monomer repeating units) may constitute 1 mol. % or more, such as 2 mol. % or more, such as 3 mol. % or more, such as 5 mol. % or more, such as 10 mol. % or more, such as 15 mol. % or more, such as 20 mol. % or more, such as 25 mol. % or more, such as 30 mol. % or more, such as 40 mol. % or more, such as 50 mol. % or more, such as 60 mol. % or more, such as 70 mol. % or more, such as 80 mol. % or more, such as 90 mol. % or more of the maleic anhydride polymer based on the total moles of monomers utilized in making the maleic anhydride polymer. The one or more ethylenically unsaturated monomers (or one or more ethylenically unsaturated monomer repeating units) may constitute 90 mol. % or less, such as 80 mol. % or less, such as 70 mol. % or less, such as 60 mol. % or less, such as 50 mol. % or less, such as 40 mol. % or less, such as 30 mol. % or less, such as 25 mol. % or less, such as 20 mol. % or less, such as 18 mol. % or less, such as 15 mol. % or less, such as 13 mol. % or less, such as 10 mol. % or less, such as 8 mol. % or less, such as 6 mol. % or less, such as 5 mol. % or less, such as 4 mol. % or less, such as 3 mol. % or less, such as 2 mol. % or less, such as 1 mol. % or less of the maleic anhydride polymer based on the total moles of monomers utilized in making the maleic anhydride polymer. In one embodiment, such aforementioned mol. % may apply to the total amount of all ethylenically unsaturated monomers utilized in making the maleic anhydride polymer. In another embodiment, such aforementioned mol. % may apply to a single class or species of ethylenically unsaturated monomers utilized in making the maleic anhydride polymer.

Related, the one or more ethylenically unsaturated monomers (or one or more ethylenically unsaturated monomer repeating units) may constitute 1 wt. % or more, such as 2 wt. % or more, such as 3 wt. % or more, such as 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more of the maleic anhydride polymer based on the weight of the maleic anhydride polymer. The one or more ethylenically unsaturated monomers (or one or more ethylenically unsaturated monomer repeating units) may constitute 90 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1 wt. % or less of the maleic anhydride polymer based on the weight of the maleic anhydride polymer. In one embodiment, such aforementioned wt. % may apply to the total amount of all ethylenically unsaturated monomers utilized in making the maleic anhydride polymer. In another embodiment, such aforementioned wt. % may apply to a single class or species of ethylenically unsaturated monomers utilized in making the maleic anhydride polymer.

The auxiliary monomers mentioned herein may constitute 20 mol. % or less, such as 18 mol. % or less, such as 15 mol. % or less, such as 13 mol. % or less, such as 10 mol. % or less, such as 8 mol. % or less, such as 6 mol. % or less, such as 5 mol. % or less, such as 4 mol. % or less, such as 3 mol. % or less, such as 2 mol. % or less, such as 1 mol. % or less of the maleic anhydride copolymer based on the total moles of monomers utilized in making the maleic anhydride polymer. The auxiliary monomers may constitute 0 mol. % or more, such as 0.1 mol. % or more, such as 0.5 mol. % or more, such as 1 mol. % or more, such as 2 mol. % or more, such as 3 mol. % or more, such as 5 mol. % or more, such as 7 mol. % or more, such as 10 mol. % or more, such as 13 mol. % or more, such as 15 mol. % or more of the maleic anhydride copolymer based on the total moles of monomers utilized in making the maleic anhydride polymer. In one embodiment, such aforementioned mol. % may apply to the total amount of all auxiliary monomers utilized in making the maleic anhydride polymer. In another embodiment, such aforementioned mol. % may apply to a single class or species of auxiliary monomers utilized in making the maleic anhydride polymer.

Related, the auxiliary monomers may constitute 20 wt. % or less, such as 18 wt. % or less, such as 15 wt. % or less, such as 13 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1 wt. % or less of the maleic anhydride polymer based on the weight of the maleic anhydride polymer. The auxiliary monomers may constitute 0 wt. % or more, such as 0.1 wt. % or more, such as 0.5 wt. % or more, such as 1 wt. % or more, such as 2 wt. % or more, such as 3 wt. % or more, such as 5 wt. % or more, such as 7 wt. % or more, such as 10 wt. % or more, such as 13 wt. % or more, such as 15 wt. % or more of the maleic anhydride polymer based on the weight of the maleic anhydride polymer. In one embodiment, such aforementioned wt. % may apply to the total amount of all auxiliary monomers utilized in making the maleic anhydride polymer. In another embodiment, such aforementioned wt. % may apply to a single class or species of auxiliary monomers utilized in making the maleic anhydride polymer.

While not necessarily limited, the maleic anhydride polymer may have a weight average molecular weight of 1,000 g/mol or more, such as 5,000 g/mol or more, such as 10,000 g/mol or more, such as 25,000 g/mol or more, such as 35,000 g/mol or more, such as 40,000 g/mol or more, such as 45,000 g/mol or more, such as 50,000 g/mol or more, such as 60,000 g/mol or more, such as 70,000 g/mol or more, such as 80,000 g/mol or more, such as 90,000 g/mol or more, such as 100,000 g/mol or more. The maleic anhydride polymer may have a molecular weight of 1,000,000 g/mol or less, such as 750,000 g/mol or less, such as 500,000 g/mol or less, such as 250,000 g/mol or less, such as 200,000 g/mol or less, such as 150,000 g/mol or less, such as 100,000 g/mol or less, such as 80,000 g/mol or less, such as 70,000 g/mol or less, such as 60,000 g/mol or less, such as 55,000 g/mol or less, such as 50,000 g/mol or less, such as 40,000 g/mol or less, such as 30,000 g/mol or less, such as 20,000 g/mol or less, such as 10,000 g/mol or less. The molecular weight may be determined using means in the art, such as gel permeation chromatography.

Generally, the maleic anhydride polymer may have a glass transition temperature of −50° C. or more, such as −40° C. or more, such as −30° C. or more, such as −20° C. or more, such as −10° C. or more, such as 0° C. or more, such as 10° C. or more, such as 20° C. or more, such as 30° C. or more, such as 40° C. or more, such as 50° C. or more, such as 60° C. or more, such as 70° C. or more, such as 80° C. or more, such as 90° C. or more, such as 100° C. or more, such as 110° C. or more, such as 120° C. or more, such as 130° C. or more, such as 140° C. or more, such as 150° C. or more. The glass transition temperature may be 250° C. or less, such as 240° C. or less, such as 230° C. or less, such as 220° C. or less, such as 210° C. or less, such as 200° C. or less, such as 190° C. or less, such as 180° C. or less, such as 170° C. or less, such as 160° C. or less, such as 150° C. or less, such as 140° C. or less, such as 130° C. or less, such as 120° C. or less, such as 110° C. or less, such as 100° C. or less, such as 90° C. or less, such as 80° C. or less, such as 70° C. or less, such as 60° C. or less, such as 50° C. or less, such as 40° C. or less, such as 30° C. or less. The glass transition temperature may be determined using means generally known in the art, such as differential scanning calorimetry.

Generally, the maleic anhydride polymer may be present in the gypsum core in a particular amount. For instance, the maleic anhydride polymer may be present in an amount of 0.0001 wt. % or more, such as 0.001 wt. % or more, such as 0.005 wt. % or more, such as 0.01 wt. % or more, such as 0.02 wt. % or more, such as 0.03 wt. % or more, such as 0.05 wt. % or more, such as 0.07 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the maleic anhydride polymer may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.09 wt. % or less, such as 0.08 wt. % or less, such as 0.07 wt. % or less, such as 0.06 wt. % or less, such as 0.05 wt. % or less, such as 0.04 wt. % or less, such as 0.03 wt. % or less, such as 0.02 wt. % or less, such as 0.01 wt. % or less. In one embodiment, the aforementioned weight percentage may be based on the weight of the gypsum panel. In another embodiment, the aforementioned weight percentage may be based on the gypsum core's weight. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

The maleic anhydride polymer may be present in the gypsum panel in an amount of 0.0001 lbs/MSF to 50 lbs/MSF, including all increments of 0.0001 lbs/MSF therebetween. For instance, the maleic anhydride polymer may be present in the gypsum panel in an amount of 0.0001 lbs/MSF or more, such as 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more. Generally, the maleic anhydride polymer may be present in the gypsum panel in an amount of 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In general, the composition of the gypsum core is not necessarily limited and may include any additives as known in the art. For instance, the additives may include other dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, graphite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches (such as pregelatinized starch, non-pregelatinized starch, and/or an acid modified starch), sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present disclosure.

Each additive may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

As indicated above, the additives may include at least one dispersant other than the maleic anhydride polymer as disclosed herein. The dispersant is not necessarily limited and may include any that can be utilized within the gypsum slurry and resulting gypsum core. The dispersant may include carboxylates, sulfates, sulfonates, phosphates, mixtures thereof, etc. For instance, in one embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof. In another embodiment, the dispersant may include a carboxylate, such as a carboxylate ether and in particular a polycarboxylate ether or a carboxylate ester and in particular a polycarboxylate ester. In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In one embodiment, the maleic anhydride polymer may be sufficiently effective such that there is no need for it to be combined with other dispersants. In this regard, such additional dispersants may not be present in the gypsum core. In this regard, such other additional dispersants may be present in an amount of 0.2 wt. % or less, such as 0.15 wt. % or less, such as 0.1 wt. % or less, such as 0.05 wt. % or less, such as 0.01 wt. % or less based on the weight of the gypsum core. Such aforementioned weight percentages may apply to all other dispersants in one embodiment. In a further embodiment, such aforementioned weight percentages may apply to a combination of select other dispersants as mentioned herein. In another embodiment, such aforementioned weight percentages may apply to any single dispersant as mentioned herein.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present disclosure is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. The first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes a maleic anhydride polymer. In this regard, the method may include a step of also combining a maleic anhydride polymer with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present disclosure. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present disclosure.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to stucco, water, and the maleic anhydride polymer, the gypsum slurry may also include any other conventional additives as known in the art. In this regard, such additives are not necessarily limited by the present disclosure. For instance, the additives may include other dispersants, foam or foaming agents including aqueous foam (e.g. sulfates such as alkyl sulfates, alkyl ether sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, graphite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present disclosure.

Each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. In one embodiment, the aforementioned weight percentage may be based on the weight of the gypsum slurry. In another embodiment, the aforementioned weight percentage may be based on the solids content of the gypsum slurry. In a further embodiment, the aforementioned weight percentage may be based on the stucco in the gypsum slurry.

The foaming agent may be one generally utilized in the art. Such foaming agent may be combined with the stucco, water, and the maleic anhydride polymer. In this regard, such foaming agent may be present in the gypsum slurry as well as the resulting gypsum core and gypsum panel.

The foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate.

The alkyl sulfate may have a general formula as follows:

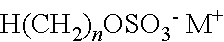

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

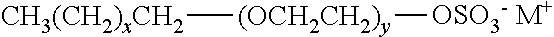

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

When a mixture of an alkyl sulfate and an alkyl ether sulfate is present, the alkyl ether sulfate may be present in an amount of from more than 0 wt. % to less than 100 wt. %. For instance, in the mixture, the alkyl ether sulfate may be present in an amount of more than 0 wt. %, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In the mixture, the alkyl ether sulfate may be present in an amount of less than 100 wt. %, such as 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less. Such weight percentage may be based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 0.001 or more, such as 0.005 or more, such as 0.01 or more, such as 0.05 or more, such as 0.1 or more, such as 0.2 or more, such as 0.3 or more, such as 0.5 or more, such as 1 or more, such as 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less, such as 3 or less, such as 2 or less, such as 1 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties.

In one aspect, the foam may be provided in an amount of 1 lb/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 50 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less, such as 80 lbs/MSF or less, such as 60 lbs/MSF or less, such as 50 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant other than the maleic anhydride polymer as disclosed herein. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof. In another embodiment, the dispersant may include a carboxylate, such as a carboxylate ether and in particular a polycarboxylate ether or a carboxylate ester and in particular a polycarboxylate ester. In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In one embodiment, the maleic anhydride polymer may be sufficiently effective such that there is no need for it to be combined with other dispersants. In this regard, such additional dispersants may not be present in the gypsum slurry. In this regard, such other additional dispersants may be present in an amount of 0.2 wt. % or less, such as 0.15 wt. % or less, such as 0.1 wt. % or less, such as 0.05 wt. % or less, such as 0.01 wt. % or less based on the weight of the gypsum slurry. Such aforementioned weight percentages may apply to all other dispersants in one embodiment. In a further embodiment, such aforementioned weight percentages may apply to aa combination of select other dispersants as mentioned herein. In another embodiment, such aforementioned weight percentages may apply to any single dispersant as mentioned herein.

As indicated above, the additives may include a starch. The starch may be one generally utilized in the art. Such starch may be combined with the stucco, water, and the maleic anhydride polymer. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

In one embodiment, when present, the pearl starch may be in the gypsum core in a particular amount. The pearl starch may be present in a reduced amount, such as an amount of less than 3 wt. % or less, such as 2.5 wt. % or less, such as 2 wt. % or less, such as 1.5 wt. % or less, such as 1 wt. % or less, such as 0.8 wt. % or less, such as 0.5 wt. %, such as 0.4 wt. % or less, such as 0.35 wt. % or less, such as 0.3 wt. % or less, such as 0.2 wt. % or less, such as 0.15 wt. % or less, such as 0.1 wt. % or less, such as 0.05 wt. % or less, such as 0.01 wt. % or less. In one embodiment, the gypsum core may not include any and thus may be free of pearl starch. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the aforementioned weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present disclosure.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

Generally, the starch may be present in the gypsum core in a particular amount. For instance, the starch may be present in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more, such as 5 wt. % or more. In some aspects, the starch may be present in an amount of 15 wt. % or less, such as 12 wt. % or less, such as 10 wt. % or less, such as 8 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less, such as 0.05 wt. % or less. In one embodiment, the aforementioned weight percentage may be based on the weight of the gypsum panel. In another embodiment, the aforementioned weight percentage may be based on the weight of the gypsum core. In a further embodiment, such aforementioned weight percentage may be based on the weight of a respective gypsum core layer. In an even further embodiment, the weight percentage may be based on the solids content of the gypsum slurry. Moreover, the aforementioned weight percentage may be based on the weight of the stucco in the gypsum slurry. Additionally, the aforementioned weight percentage may be based on the weight of the gypsum in the gypsum core. In an additional embodiment, the aforementioned weight percentage may be based on the weight of the gypsum in the respective gypsum core layer.

The manner in which the components (e.g., stucco, water, maleic anhydride polymer) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Furthermore, regarding the maleic anhydride polymer, it may be provided as a solid. Alternatively, it may be dissolved in water initially. In particular, the water utilized for providing the maleic anhydride polymer may be the same water as that utilized to provide the foaming agent. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present disclosure.

In one embodiment, the gypsum core may include a first gypsum core layer and a second gypsum core layer. The first gypsum core layer may be between the first facing material (i.e., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as a maleic anhydride polymer. Further, the first gypsum core layer, the second gypsum core layer, and/or the third gypsum core layer may contain an additive in an amount as previously indicated herein.

As indicated herein, the gypsum core can include a maleic anhydride polymer. In this regard, in one embodiment, the first gypsum core layer may include a maleic anhydride polymer as disclosed herein. In another embodiment, the second gypsum core layer may include a maleic anhydride polymer as disclosed herein. In a further embodiment, the third gypsum core layer may include a maleic anhydride polymer as disclosed herein. In an even further embodiment, the first gypsum core layer and the second gypsum core layer may include a maleic anhydride polymer as disclosed herein. In another further embodiment, the first gypsum core layer, the second gypsum core layer, and the third gypsum core layer may include a maleic anhydride polymer as disclosed herein. In yet another embodiment, a maleic anhydride polymer may be included adjacent to the first facing material and/or the second facing material.

Regardless of the above, a maleic anhydride polymer may be present in any combination of gypsum core layers. However, in one embodiment, it should be understood that one or two of the aforementioned gypsum core layers may not include a maleic anhydride polymer. In one aspect, one or more gypsum core layers may comprise the same maleic anhydride polymer. Further, in one aspect, the one or more gypsum core layers may comprise different maleic anhydride polymers. The different maleic anhydride polymers of the one or more gypsum core layers may be chosen such that it is advantageous to have a particular maleic anhydride polymer in one gypsum core layer and a different maleic anhydride polymer in another, different gypsum core layer.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 10 pcf or more, such as about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C₁₃₉₆-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C₁₃₉₆-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C₄₇₃-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C₁₃₉₆-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C₁₃₉₆-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C₁₃₉₆-17 and ASTM C₄₇₃-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C₁₃₉₆-17 and ASTM C₄₇₃-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. The facing material may cover more than 0%, such as 5% or more, such as 10% or more, such as 20% or more, such as 30% or more, such as 40% or more, such as 50% or more, such as 60% or more, such as 70% or more, such as 80% or more, such as 85% or more, such as 90% or more, such as 93% or more, such as 95% or more, such as 98% or more, such as 99% or more of the surface area of the gypsum core. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels. In one embodiment, the aforementioned test may be performed upon conditioning for 20 hours in a humidity chamber at 90° F. and 90% humidity.

Also, stated in other words, the aforementioned humidified bond may have a percentage failure, which would indicate the inverse of the above percent coverage. For instance, the percentage failure would be indicative of the amount of facing material removed thereby exposing a certain area or percentage of the gypsum core. In this regard, after exposure, the percent failure may be 0% or more, such as 1% or more, such as 2% or more, such as 3% or more, such as 4% or more, such as 5% or more, such as 8% or more, such as 10% or more, such as 15% or more, such as 20% or more, such as 25% or more, such as 30% or more, such as 35% or more, such as 40% or more, such as 50% or more. The percentage failure may be less than 100%, such as 90% or less, such as 80% or less, such as 70% or less, such as 60% or less, such as 50% or less, such as 40% or less, such as 30% or less, such as 25% or less, such as 20% or less, such as 15% or less, such as 12% or less, such as 10% or less, such as 8% or less, such as 6% or less, such as 4% or less, such as 3% or less, such as 2% or less, such as 1% or less. Similarly, such percent failure may be determined using various optical analytical techniques. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Example 1

Gypsum panels were made using a conventional dispersant in and compared against inventive gypsum panels formed using a maleic anhydride polymer, in particular a 2,5 furandione 2,4,4-trimethylpentene polymer. The gypsum panels had a thickness of ½″.

The gypsum panels were analyzed to determine the panel weight and the effect of the maleic anhydride polymer on the panel properties, particularly in comparison to a gypsum panel made using a conventional naphthalene sulfonate dispersant.

| | | | | | 2 hr | 2 hr |
|---|---|---|---|---|---|---|
| | | | | | Humidified | Humidified |
| | | | Panel | Nail- | Bond | Bond |
| | Dispersant | Soap | Weight | Pull | (front) | (back) |
| | (lbs/MSF) | (lbs/MSF) | (lbs/MSF) | (lb_{f}) | (% failure) | (% failure) |
| naphthalene | 2.15 | 0.55 | 1416 | 71 | 1 | 4 |
| sulfonate | 2.28 | 0.5 | 1494 | 82 | 1 | 1 |
| (control) | | | | | | |
| 2,5 furandione | 0.71 | 0.375 | 1385 | 74 | 2 | 4 |
| 2,4,4 - | 0.77 | 0.325 | 1522 | 83 | 1 | 1 |
| trimethylpentene | | | | | | |
| polymer | | | | | | |

As indicated in the table above, the panels exhibit similar nail pull and humidified bond failures with the maleic anhydride polymer at ⅓ the usage of the maleic anhydride polymer compared to the naphthalene sulfonate dispersant. In addition, the soap (foaming agent) usage was also reduced by about 30%.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core comprising gypsum and a maleic anhydride polymer comprising maleic anhydride repeating units in an amount of more than 10 wt. % based on the weight of the maleic anhydride polymer, and
a first facing material and a second facing material sandwiching the gypsum core.

2. The gypsum panel of claim 1, wherein the maleic anhydride repeating units constitute an amount of 25 wt. % or more of the maleic anhydride polymer based on the weight of the maleic anhydride polymer.

3. The gypsum panel of claim 1, wherein the maleic anhydride polymer comprises a maleic anhydride homopolymer.

4. The gypsum panel of claim 1, wherein the maleic anhydride polymer comprises a maleic anhydride copolymer.

5. The gypsum panel of claim 1, wherein the maleic anhydride polymer comprises maleic anhydride repeating units and repeating units of one or more ethylenically unsaturated monomers.

6. The gypsum panel of claim 5, wherein the one or more ethylenically unsaturated monomers comprise an acrylic acid or an ester thereof, a vinyl ether, a vinyl ester, a vinyl halide, a vinyl aromatic, or a mixture thereof.

7. The gypsum panel of claim 5, wherein the one or more ethylenically unsaturated monomers comprise an olefin.

8. The gypsum panel of claim 7, wherein the olefin comprises 2 or more to 10 or less carbon atoms.

9. The gypsum panel of claim 1, wherein the maleic anhydride polymer comprises maleic anhydride repeating units and 2,4,4-trimethyl-1-pentene repeating units.

10. The gypsum panel of claim 5, wherein the repeating units of one or more ethylenically unsaturated monomers constitute 1 wt. % or more to 90 wt. % or less of the maleic anhydride polymer based on the weight of the maleic anhydride polymer.

11. The gypsum panel of claim 1, wherein the maleic anhydride polymer comprises a metal salt.

12. The gypsum panel of claim 11, wherein the maleic anhydride polymer comprises a sodium salt.

13. The gypsum panel of claim 1, wherein the maleic anhydride polymer is present in an amount of 0.01 wt. % or more to 5 wt. % or less based on the weight of the gypsum core.

14. The gypsum panel of claim 1, wherein the maleic anhydride polymer is present in an amount of 0.1 wt. % or more to 3 wt. % or less based on the weight of the gypsum core.

15. The gypsum panel of claim 1, wherein the maleic anhydride polymer is present in an amount of 0.2 wt. % or more to 1 wt. % or less based on the weight of the gypsum core.

16. The gypsum panel of claim 1, wherein the gypsum is present in an amount of at least 60 wt. % based on the weight of the gypsum core.

17. The gypsum panel of claim 1, wherein the gypsum core comprises a further dispersant.

18. The gypsum panel of claim 17, wherein the further dispersant comprises naphthalene sulfonate, naphthalene sulfonate formaldehyde condensate, sodium naphthalene sulfonate formaldehyde condensate, lignosulfonate, melamine formaldehyde condensate, a polycarboxylate ether, a polycarboxylate ester, or a mixture thereof.

19. The gypsum panel of claim 1, wherein the gypsum panel exhibits a nail pull resistance of at least about 70 lb_{f} when tested in accordance with ASTM C₁₃₉₆-17.

20. The gypsum panel of claim 1, wherein the gypsum panel exhibits a nail pull resistance of at least about 77 lb_{f} when tested in accordance with ASTM C₁₃₉₆-17.

21. A method for making a gypsum panel, the method comprising:
providing a first facing material;
depositing a gypsum slurry comprising stucco, water, and a maleic anhydride polymer comprising maleic anhydride repeating units in an amount of more than 10 wt. % based on the weight of the maleic anhydride polymer onto the first facing material;
providing a second facing material on the gypsum slurry; and
allowing the stucco to convert to calcium sulfate dihydrate.
